(19) United States
(12) Patent Application Publication
(10) Pub. No.: US 2023/0269405 A1
(43) Pub. Date: Aug. 24, 2023

(54) NON-FINGERPRINT-BASED AUTOMATIC CONTENT RECOGNITION

(71) Applicant: Samba TV, Inc., (US)

(72) Inventor: Alexander Clifford Hunt QUINN, Red Bud, IL (US)

(21) Appl. No.: 18/111,462

(22) Filed: Feb. 17, 2023

Related U.S. Application Data
(60) Provisional application No. 63/311,597, filed on Feb. 18, 2022.

(51) Int. Cl. H04N 21/234; G06T 7/11; G06T 7/00

(52) U.S. Cl. CPC H04N 21/23418; G06T 7/11; G06T 7/0002; G06T 2207/30168; G06T 2207/10016

(57) ABSTRACT

A method for content recognition. The method may include sampling a source content for performing content recognition; detecting content elements from the sampled source content; and identifying the detected content elements, wherein detecting the content elements from the sampled source content comprises: detecting the content elements using an element detection model; and generating bounding boxes over the detected content elements. In one exemplary embodiment, each bounding box corresponds to a detected content element, and each detected content element is a detected face, slogan, logo, symbol, location, word, jingle, brand, trade name, trademark, landmark, building, visual work, audio work, audiovisual work, and/or any other product or item of unique interest, etc.

### BACKGROUND

This application claims priority under 35 U. S. C. 119(a) to U.S. Provisional Application No. 63/311,597, filed on Feb. 18, 2022, the content of which is incorporated herein in its entirety for all purposes.

### FIELD

The present disclosure is related to the field of automatic content recognition (ACR), and more particularly to systems and methods for automatic content recognition that avoid the need to create and store a fingerprint of the content.

### RELATED ART

In recent years, edge-cloud systems and the collaboration of edge computing and cloud computing have been attracting attention with data growth due to the rapid development of the Internet of Things (IoT) and 5G technologies. Based on the requirements of applications, IoT data may be processed at an edge, on a cloud, or somewhere in between. The more IoT data the system gathers or the more advanced process it executes, the more complicated things become due to the number of applications processing the data and/or the amount of computing resources to be allocated. In edge-cloud systems, applications are expected to be deployed flexibly so as to allow easy installation by users.

Automatic content recognition, or ACR, means the ability to identify content. Typically, the content is a distinct part or section associated with a visual work (e.g., a photograph, painting, or digital image), an audio work (e.g., a song, speech, performance, or sound recording), or an audiovisual work (e.g., a dramatic work, film, television program, or video clip). A work can also contain multiple distinct audio, visual, or audio-visual works within the work itself, such as a film within a film, or a photograph, painting, song, speech, performance, sound recording, or digital image within a dramatic work, film, television program, or video clip. Also, typically, ACR can be implemented as software operating on a computer device, and the content can be performed or displayed in proximity to, or on, the computer device on which the software is operating. The software may use sensors associated with the computer device (e.g., microphones, cameras) to detect the proximate performance or display, sample a portion of the performance or display, process and analyze the sample, and compare it with a reference library of content to identify the content based on unique characteristics in the sample.

For example, the mobile device application SoundHound™ performs ACR for audio works to help users identify an unknown song that is currently being played. The user operates a graphical user interface control to cause the application to turn on the device's microphone and “listen” to nearby audible signals to collect a sample of the song currently being played. That sample is then compared to a reference library to identify the song. Typically, the client application on the device does not have direct access to the reference library. Instead, the sample is transmitted over a telecommunications network (e.g., the Internet), to a server computer for processing and comparison, and the identity of the song (if discernable) is determined by the server, and returned to the software application for display to the user. This technology can also be used to identify sub-elements of content. For example, the SoundHound™ application referenced above can be used to identify a song playing in the background of a film.

ACR technology can also be used to identify content that is not detected in the environment, but rather stored on the device's storage medium (e.g., in a media file), or received by the device, such as via a telecommunications network (e.g., a content stream). When used to identify content being displayed or performed via the device itself, ACR is said to be operating “at the screen level.” Unlike the SoundHound™ example, where the user is directing the collection, ACR can be used to collect content consumption data without requiring direct feedback from the user. Such data can then be used to further customize and personalize the user experience, such as through personalized advertising and recommendations. The data may also be commercially valuable to customer data aggregators, retailers, and the like.

ACR technologies rely on two primary identification techniques: fingerprinting and watermarking. “Fingerprinting” is the process of generating from a content source a condensed digital summary of its content. The fingerprinting process uses a deterministic algorithm (i.e., a computer program that, when given the same input, will always produce the same output), to identify unique or distinguishing characteristics of the content source and generate a unique signature for it (i.e., the “fingerprint”). These fingerprints are then aggregated into a fingerprint database. The client software conducting the sampling performs, essentially, the same process on the sample, and the resulting sample fingerprint is then compared to the fingerprint database to identify the best match.

The other major ACR technology is digital watermarking, in which an identifier is embedded within the content. These watermarks, sometimes also known as “tags,” are inserted prior to distribution of the content, and are usually not discernable to the consumer. However, they can be detected by a computer to identify the content being displayed or performed.

These techniques have the advantage of relying entirely on the content itself, as opposed to technological aspects of content storage and delivery, which are less reliable and accurate and may not always be available. For example, a user sitting in a restaurant and hearing a song she wants to identify will not have access to any technical information about the song media file itself that could be used to identify it.

Both techniques also have disadvantages, however. Watermarks depend on the watermark being created and inserted prior to distribution in the first instance, and not later removed, and thus are dependent on the choices of the producer. If a given copy of a content lacks a watermark, this technique does not work. Further, there are many ways to get a copy of a given content, and if the copy being sampled lacks the watermark, the technique also will not work. Watermarking thus is used primarily to detect direct illegal copies of official works but has limited value as a general-purpose, situationally agnostic ACR technique.

Fingerprinting lacks this problem, but it, too, has its shortcomings. Fingerprinting requires the creation of fingerprint reference libraries, which imposes significant overhead costs. Creating the library itself requires access to high-quality copies of the content source being fingerprinted, which is expense to acquire. The fingerprinting process itself can be computationally intensive, the resulting fingerprint reference libraries can be very large, and this process requires constant updating and maintenance for accuracy. As new works are published, new content sources must be fingerprinted.

Further, for certain types of works, notably lengthy audiovisual works like films, the sampling process can present challenges. Sampling often takes place on a client device, which typically has less processing power and, in most cases, is not designed specifically for intensive video processing. This can create bottlenecks, especially as the industry adopts increasingly high-definition, high data-density formats for video playback. If a video sample is collected and processed at the client device, the demands on the processor may create lengthy processing delays and consume limited processor resources needed for other client device operations. However, if the sample is transmitted to a server for the processing, the large size of the sample file could consume disproportionate network resources, especially over cellular data networks, and also result in lengthy end-to-end processing delays. Either way, the delay is both frustrating to the user and unnecessarily wasteful of computational and network resources.

Because of these and other problems in the art, described herein, among other things, are novel systems and methods for automated content recognition that avoid the need for watermarking or fingerprinting, and which avoid the need for a content-based reference library. Instead, the systems and method described herein utilize computer-implemented and computer-applied sequences of rules and logic to detect and identify discrete items within a content element, and, based on those identifications, determine the identity of the content element being displayed or performed. This identification uses ancillary data about content elements to create sets of candidate matches and calculate the intersection of those matches. This process is repeated until the intersection of all such sets contains either a single match (i.e., the identity of the content element), or zero matches (i.e., failure to identify the work). These elements can be performed in various orderings and sequences in various embodiments depending upon the particular use case. Conceptually, the systems and methods described herein provide a service similar to a search engine, in which input is received, processed, and databases of potentially relevant results are examined. However, whereas a search engine takes written text as input and produces a set of all possible responses, the systems and methods described herein sample content elements, including audiovisual content elements, such as a face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc., and iteratively repeat the search-and-match process to create multiple sets of results until there is only a single shared result among all of the sets, and this one shared result is provided as the result of the systems and methods described herein.

### SUMMARY

Aspects of the present disclosure involve an innovative method for content recognition. The method may include sampling a source content for performing content recognition; detecting content elements from the sampled source content; and identifying the detected content elements, wherein detecting the content elements from the sampled source content comprises: detecting the content elements using an element detection model; and generating bounding boxes over the detected content elements, wherein each bounding box corresponds to a detected content element, and each detected content element is a detected face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc.

Aspects of the present disclosure involve an innovative non-transitory computer readable medium, storing instructions for content recognition. The instructions may include sampling a source content for performing content recognition; detecting content elements from the sampled source content; and identifying the detected content elements, wherein detecting the content elements from the sampled source content comprises: detecting the content elements using an element detection model; and generating bounding boxes over the detected content elements, wherein each bounding box corresponds to a detected content element, and each detected content element is a detected face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc.

Aspects of the present disclosure involve an innovative server system for content recognition. The server system may include sampling a source content for performing content recognition; detecting content elements from the sampled source content; and identifying the detected content elements, wherein detecting the content elements from the sampled source content comprises: detecting the content elements using an element detection model; and generating bounding boxes over the detected content elements, wherein each bounding box corresponds to a detected content element, and each detected content element is a detected face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc.

Aspects of the present disclosure involve an innovative system for content recognition. The system can include means for sampling a source content for performing content recognition; means for detecting content elements from the sampled source content; and means for identifying the detected content elements, wherein means for detecting the content elements from the sampled source content comprises: means for detecting the content elements using an element detection model; and means for generating bounding boxes over the detected content elements, wherein each bounding box corresponds to a detected content element, and each detected content element is a detected face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc.

Aspects of the present disclosure involve an innovative method for content recognition. The method may include extracting, by a server, embedding on a face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc. associated with a content element; matching, by the server, extracted embedding against stored embeddings at a library to locate an identity of the content element; and outputting, by the server the located identity as the identity of the content element, wherein at least one of extracting or matching is performed by a machine learning model.

Aspects of the present disclosure involve an innovative non-transitory computer readable medium, storing instructions for content recognition. The instructions may include extracting, by a server, embedding on a face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc. associated with a content element; matching, by the server, extracted embedding against stored embeddings at a library to locate an identity of content element; and outputting, by the server the located identity as the identity of the content element, wherein at least one of extracting or matching is performed by a machine learning model.

Aspects of the present disclosure involve an innovative server system for content recognition. The server system may include sampling a source content for extracting, by a server, embedding on a face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc. associated with a content element; matching, by the server, the extracted embedding against stored embeddings at a library to locate an identity of the content element; and outputting, by the server the located identity as the identity of the content element, wherein at least one of extracting or matching is performed by a machine learning model.

Aspects of the present disclosure involve an innovative system for content recognition. The system can include means for extracting, by a server, embedding on a face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest, etc. associated with a content element; means for matching, by the server, the extracted embedding against stored embeddings at a library to locate an identity of the content element; and means for outputting, by the server the located identity as the identity of the content element, wherein at least one of extracting or matching is performed by a machine learning model.

Aspects of the present disclosure involve an innovative method for content recognition. The method may include sampling, by a processor, a source content; detecting, by the processor, a first content element from the sampled source content; identifying, by the processor, the detected first content element; searching, by the processor, for at least one matching work associated with the identified first content element; grouping, by the processor, the at least one matching work associated with the identified first content element into a first set of works; detecting, by the processor, a second content element from the sampled source content; identifying, by the processor, the detected second content element; searching, by the processor, for at least one matching work associated with the identified second content element; grouping, by the processor, the at least one matching work associated with the identified second content element into a second set of works; determining, by the processor, whether an intersecting work exists between the first set of works and the second set of works; and finding an intersecting work among the first set of works and the second set of works, and outputting, by the processor, the intersecting work as an identity of the source content.

Aspects of the present disclosure involve an innovative non-transitory computer readable medium, storing instructions for content recognition. The instructions may include sampling, by a processor, a source content; detecting, by the processor, a first content element from the sampled source content; identifying, by the processor, the detected first content element; searching, by the processor, for at least one matching work associated with the identified first content element; grouping, by the processor, the at least one matching work associated with the identified first content element into a first set of works; detecting, by the processor, a second content element from the sampled source content; identifying, by the processor, the detected second content element; searching, by the processor, for at least one matching work associated with the identified second content element; grouping, by the processor, the at least one matching work associated with the identified second content element into a second set of works; determining, by the processor, whether an intersecting work exists between the first set of works and the second set of works; and finding an intersecting work among the first set of works and the second set of works, and outputting, by the processor, the intersecting work as an identity of the source content.

Aspects of the present disclosure involve an innovative server system for content recognition. The server system may include sampling, by a processor, a source content; detecting, by the processor, a first content element from the sampled source content; identifying, by the processor, the detected first content element; searching, by the processor, for at least one matching work associated with the identified first content element; grouping, by the processor, the at least one matching work associated with the identified first content element into a first set of works; detecting, by the processor, a second content element from the sampled source content; identifying, by the processor, the detected second content element; searching, by the processor, for at least one matching work associated with the identified second content element; grouping, by the processor, the at least one matching work associated with the identified second content element into a second set of works; determining, by the processor, whether an intersecting work exists between the first set of works and the second set of works; and finding an intersecting work among the first set of works and the second set of works, and outputting, by the processor, the intersecting work as an identity of the source content.

Aspects of the present disclosure involve an innovative system for content recognition. The system can include means for sampling, by a processor, a source content; means for detecting, by the processor, a first content element from the sampled source content; means for identifying, by the processor, the detected first content element; means for searching, by the processor, for at least one matching work associated with the identified first content element; means for grouping, by the processor, the at least one matching work associated with the identified first content element into a first set of works; means for detecting, by the processor, a second content element from the sampled source content; means for identifying, by the processor, the detected second content element; means for searching, by the processor, for at least one matching work associated with the identified second content element; means for grouping, by the processor, the at least one matching work associated with the identified second content element into a second set of works; means for determining, by the processor, whether an intersecting work exists between the first set of works and the second set of works; and means for finding an intersecting work among the first set of works and the second set of works, and means for outputting, by the processor, the intersecting work as an identity of the source content.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 is a schematic diagram of a first iteration of a non-fingerprint-based automatic content recognition system and method, in accordance with an example implementation.

FIG. 2 is a schematic diagram of a second iteration of a non-fingerprint-based automatic content recognition system and method, in accordance with an example implementation.

FIG. 3 is a schematic diagram of a third iteration of a non-fingerprint-based automatic content recognition system and method, in accordance with an example implementation.

FIG. 4 is a diagram of intersecting the first and second iterations of a non-fingerprint-based automatic content recognition system and method, in accordance with an example implementation.

FIG. 5 is a diagram of intersecting the first, second, and third iterations of a non-fingerprint-based automatic content recognition system and method, in accordance with an example implementation.

FIG. 6 is a flow chart of a method for non-fingerprint-based automatic content recognition, in accordance with an example implementation.

FIG. 7 is a flow chart of steps 605 and 607 of FIG. 6, using faces/actors as the scope or type of content detection, in accordance with an example implementation.

FIG. 8 illustrates an example process flow 800 of steps 605 and 607 of FIG. 6, where the scope/type of content detection other than face is utilized, in accordance with an example implementation.

FIG. 9 illustrates an example user device, which may include display elements (e.g., display screens or projectors) for displaying consumer content.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skill in the art practicing the implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Throughout this disclosure, the term “computer” describes hardware that generally implements functionality provided by digital computing technology, particularly computing functionality associated with microprocessors. The term “computer” is not necessarily limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, set top cable boxes, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices that are not conventionally thought of as “computers” may, in some instances, exhibit the characteristics of a “computer” and could be considered a “computer” within the scope of this definition. For example, in certain contexts, where such a device is performing the functions of a “computer” as described herein, the term “computer” could include such devices to that extent. Devices of this type include, but are not necessarily limited to: network hardware, print servers, file servers, NAS and SAN, load balancers, and other hardware capable of, or adapted or configured for, interacting with the systems and methods described herein in the manner of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer-readable media having computer-readable program code embodied thereon.

Any combination of one or more computer-readable media may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electromagnetic optical, or any suitable combination thereof. A computer-readable signal medium may be any computer-readable medium that is not a computer-readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer-readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other.

Throughout this disclosure, the term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a web site”), or an access point for a service over a network.

Throughout this disclosure, the term “real time” refers to steps, processes, or other activity occurring within operational deadlines to present to a human user the perception or impression that the activity in question is effectively occurring contemporaneously with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of about one second or less of real time, with milliseconds or microseconds being preferable. However, those of ordinary skill in the art also understand that, under other operational contexts, a system operating in “real time” may exhibit delays longer than one second, particularly where network operations are involved.

As used throughout this disclosure, “mobile device” means a portable computer system in the nature of a smart phone, tablet PC, e-reader, fitness device (e.g., a Fitbit™ or Jawbone™) or any other mobile computer, whether of general or specific purpose functionality. Generally speaking, a mobile device is network-enabled and communicating with a server system providing services over a network. A mobile device is essentially a mobile computer usually associated more strongly with a user than with a particular location, and is also commonly carried on a user's person, and usually is in near-constant real-time communication with a network.

As used throughout this disclosure, “content” means the information, data, and experiences directed to an end-user or audience, usually in a media field such as, but not necessarily limited to, publishing, art, entertainment, and communication. As used herein, the term “content” is generally media-, format-, distribution-, and presentation-agnostic. For example, the “content” of the film Rocky (1976) is the audiovisual experience directed to the audience or consumer of the film, regardless of media (e.g., chemically printed cinema reels, Blu-Ray™ disc, digital media file download), distribution (e.g., television broadcast, Internet stream, etc.), or format (e.g., AVI, MPEG, QuickTime, Windows Media Video, dimension, pixel density, aspect ratio, pan-and-scan, etc.).

As used throughout this disclosure, the term “content element” refers to an element of content. For a visual or audiovisual work, this is generally a discrete element depicted visually in the work, such as a face, person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest. A content element may also (or alternatively) be or include an audio element, such as a song, voice, audibly spoken words, sound or sound effect, or acoustic or rhythmic elements, such as (without limitation) tones, notes, pitches, pauses, instruments, chords, rhythms, melodies, vocalizations, lyrics, loudness, and so forth. Where content is an audio work only, the content elements will of course be audio elements.

As used throughout this disclosure, the terms “detect” and “identify” have different meanings. The term “detect” should be understood as recognizing discrete content element(s) within content. In the context of this disclosure, such detections are generally performed programmatically by a computer using image recognition and acoustic recognition techniques now known in the art or developed in the future. These techniques recognize the presence of a content element, but they do not necessarily identify the content element. Identification differs in that it provides a name, title, or description of the recognized element on either an individual or a categorical basis.

The difference between detection and identification may be best understand by reference to examples. The most common anticipated use case, for purposes of this disclosure, will be to detect and identify a person in content, typically with reference to the person's face. “Identify” in this context refers to determining the name of the person detected. In works of fiction, either the actor or the character being portrayed can be identified (e.g., “Mark Hamill” or “Luke Skywalker”). There may be use cases in which the actor may be impossible, or unnecessary, to identify, and it is only possible, or necessary, to identify the character portrayed. This may be the case where the actor's face is not visible, such as due to costuming (e.g., Davis Prowse portraying “Darth Vader” in the Star Wars franchise) or motion capture (e.g., Andy Serkis portraying “Gollum” in The Lord of the Rings films, or Sam Worthington, portraying “Sully” in the Avatar film). There may also be circumstances where the precise identification of the actor is not possible (or necessary) due to unique circumstances, such as content in which twin actors play the same character. For example, young characters are often played by twin child actors to extend production hours, and twin actors are sometimes utilized for stunts and special effects (e.g., Linda and Leslie Hamilton both portraying “Sarah Connor” for an unused special effect in Terminator 2). In this case, “identifying” the actor as Linda Hamilton, even if the particular person in the content is Leslie Hamilton, is sufficient.

In other contexts and implementations, the distinction between detecting and identifying may be categorical. For example, content may contain a Boeing 747 airliner as a content element, and this content element may be detected as an “aircraft” and then identified as a Boeing 747. Likewise, a content element might be detected as a first category (e.g., an “automobile”) and then identified as a more specific category (e.g., a DMC DeLorean). In still other cases, detection may be categorical and identification may be even more specific. For example, an aircraft may be identified not only as a Boeing 747, but as Air Force One, and an automobile may be identified not only as a DMC DeLorean, but as the time machine from Back to the Future.

As discussed elsewhere herein, identification is generally used to create a set of possible answers that includes the identified content element. Because the ultimate goal is to produce sets whose intersection is a single work, generally a more specific identification that results in a smaller set of candidate matches is preferred. However, also as described herein, in instances where the resulting intersection produces a null set, one or more identifications may be re-performed at a more generalized, categorical level in an attempt to find an intersection.

It should also be noted that there be instances in which detection and identification overlap significantly, such as where the detected object is “one of a kind” and, once detected, it is effectively identified. Examples include distinctive buildings, skylines, and geographic or geological features, such as, for example, the Statute of Liberty. In such instances, both steps are still effectively performed.

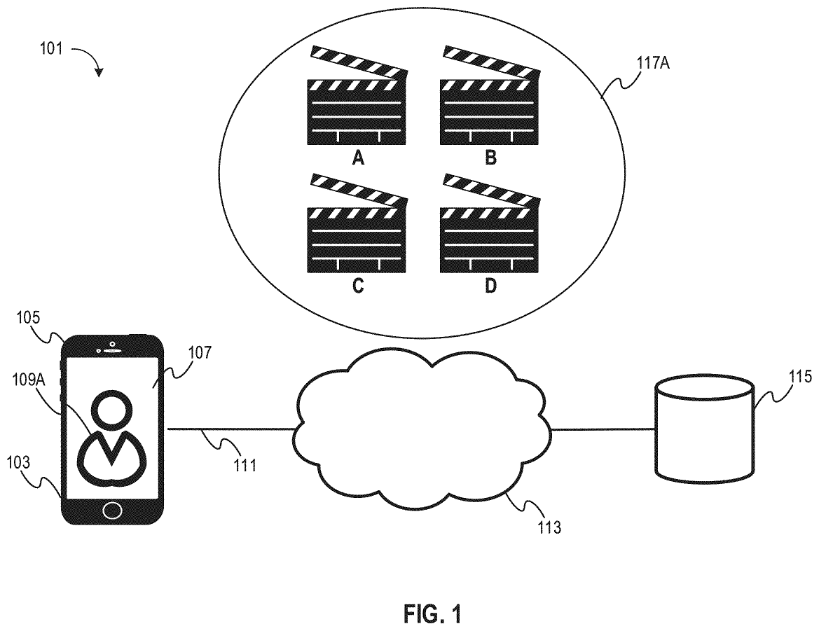

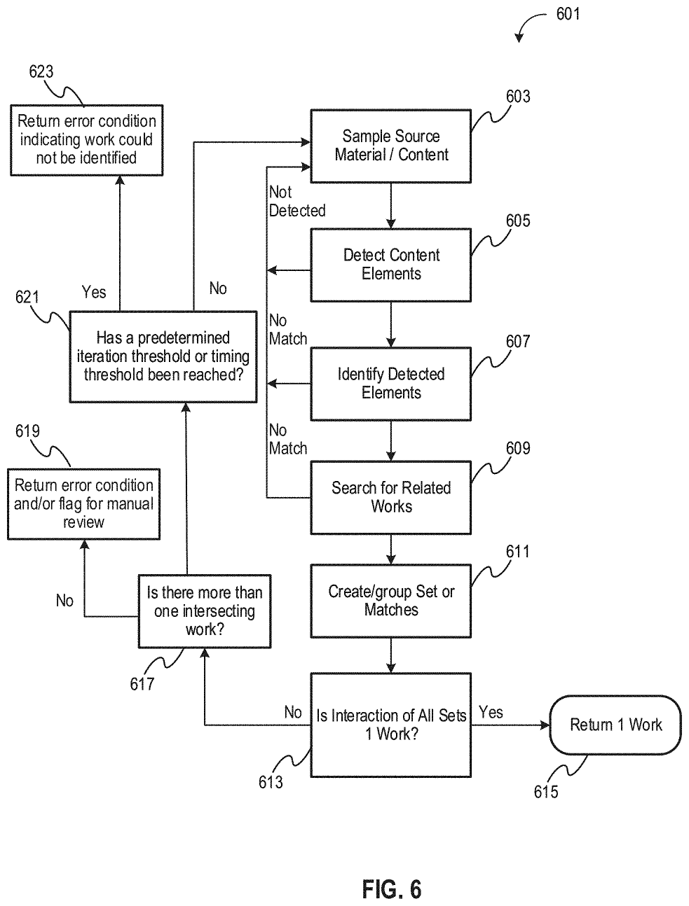

FIG. 1 depicts an exemplary embodiment of a system (101) for conducting non-fingerprint-based automatic content recognition according to the present disclosure. FIG. 6 also depicts a flow chart of the method (601). The method shown in FIG. 6 may be implemented by the system depicted in FIG. 1, and the system depicted in FIG. 1 may implement the method shown in FIG. 6.

In the depicted embodiments, content (107) is accessible to a computer (103). The content may be stored on a media or streamed via a telecommunications network (113), and in the typical case is an audiovisual work (107), such as a television show, cinematic work, and so forth. This disclosure will be made primarily with reference to examples in which an audiovisual work is used, but it will be clearly understood that this is not limiting and the techniques described herein may be applied to other types of works.

The computer (103) may be any computer capable of, or configured or adapted to, receive and process content (107). In the typical case, the computer (103) will have a display (105) for presenting the content (107). A mobile device (103) is depicted in FIG. 1 but this is by no means limiting and computer (103) may be a smart television, wearable device, or any other computer with sufficient processing capabilities. The content (107) will typically be displayed on a display (105) associated with the computer (103) when the method is being carried out, but this is again not necessarily required, and non-fingerprint-based ACR techniques described herein may be used on stored or streamed content without display (105). Likewise, a display (105) physically affixed to the computer (103) is shown but this is again not limiting and there may be embodiments in which the display (105) and computer (103) are physically distinct devices, or in which a display (105) is not used at all. However, this disclosure will describe non-fingerprint-based ACR in the anticipated most typical but non-limiting case of a computer (103) with an integrated display (105).

In the depicted embodiment, the content (107) is displayed on the display (103) and a computer software program associated with the computer (103) is used to sample the content (603). This may be done in response to a user request to identify the content (107), and thus the content (107) displayed at or near the time of the request will be initially sampled (603), but this may also be done automatically without user input. Techniques for sampling the content will vary depending on the nature of the content (107) and are generally known in the art, such as by taking a screen capture of a still frame of an audiovisual work. In an embodiment, a copy of the sample may be stored in a media associated with the computer (103) for later reference, such as to re-perform the sampling step (603) described herein to search for additional content elements in the search steps.

Next, the software analyzes the sampled content to detect (605) at least two content elements in the sample. For example, in an audiovisual work, the presence of an actor (109A) or character (109A) in the sampled still frame may be detected. Again, techniques for recognizing a human being in an image are known and may be deployed here to extract from the sample data elements representing the visual depiction of the detected content element (109A) (e.g., additional image data excerpted from the sample). One or more content elements (109A) may be detected, depending on how many detectable content elements (109A) are in the particular frame. In cases where the sample contains no detectable content elements (109A), the sample may be discarded and a new sample taken (603) at a different point in the content (107) (e.g., for a work with a temporal element, such as an audiovisual work or musical work, some period of time in the work before or after the original sample) and the process re-started. In cases where multiple content elements (109A) are detected, the subsequent steps in the depicted method (601) are repeated for each such detected content element (109A).

Once a sample is acquired with at least one detected content element (109A), for each such detected content element (109A), the software attempts to identify (607) the detected content element (109A). As described elsewhere herein, identification generally comprises determining a unique or more specific categorical classification of the detected content element (109A). In the typical case in which the detected content element (109A) is a person (e.g., an actor or character), the name of the actor (or in some cases, the character) may be identified. Identification can be performed using any number of techniques, such as by transmitting 111 the detected content element data to a search database (115) over a telecommunications network (113), which uses the detected content element data to identify the subject. Alternatively, such a database could be housed locally in association with the computer (103). Various techniques, such as image recognition engines, are known in the art and may be used in an embodiment to conduct identification (607). If the subject cannot be identified, the content element (109A) may be discarded and not further used, and the process repeats and/or continues with other detected content elements (109A).

After the content element (109A) is identified, a search (609) is conducted for associated works in which the identified content element (109A) is known to appear, based on the identification and, in some embodiments, the type of content (107) in which the content element (109A) is detected. For example, if the identified content element (109A) is an actor, and the content (107) is a film, then a search (609) is conducted for films in which the identified actor appears. This search (609) can be performed using any number of techniques, such as by transmitting (111) the identification of the content element (109A) to a search database (115) over a telecommunications network (113). Alternatively, such as a database could be housed locally in association with the computer (103). This database (115) may be the same or different from databases used in other steps described herein. By way of example and not limitation, databases such as the Internet Movie Database™ could be used to download or access a filmography listing for a given identified actor. In some embodiments, the search is performed using a machine learning model, where the machine learning model is trained using historical searches. The results of this search (609) are then stored as a set (117A) of matching search results A, B, C, and D, as shown in FIG. 1. These results may be used to create or group into (611) a set (117A) of matching works (A, B, C, and D), which set may be stored in a data record associated with or accessible to the computer (103). If the search results consist of an empty set (e.g., no results found), other sources or searches may be performed, or the content element (109A) may simply be discarded and not further used, and the process repeats and/or continues with other detected content elements (109A). As illustrated in FIG. 6, if no content elements are detected at 605 or no match is made at 607-609, redetection of content elements and/or source content resampling is performed.

At this point, all remaining detected content elements (109A) have been identified, searched, and a non-null set of matching responses has been created, and the intersection of the sets is then determined and the number of works in the intersection is counted (613). If the intersection is a single work, then the identity of that work is returned (615) and the non-fingerprint-based ACR method has completed successfully in identifying the content (107). If the intersection is not a single work (613), the software may determine whether there is more than one intersecting work (617). If there is no intersecting work, this is generally an error condition that cannot be further resolved, and it suggests that either one of the other steps has returned erroneous results, or that databases (115) are incomplete. This error condition/message may be returned and flagged for manual review and troubleshooting by a human analyst (619).

However, if there is more than one intersecting work (i.e., it contains two or more works), then the process is repeated. That is, a new sample is taken, new content elements (109A) are detected, identified, searched, and additional search result sets are created. The intersection of all resulting sets from all iterations is used in steps (613) and (617) to determine success, error, or whether further sampling and iteration is needed.

For example, in FIG. 1, a first iteration detects a first content element (109A) and results in a first search result set (117 A) of works A, B, C, and D, in which the first content element (109A) also appears. Because there is only one set (117 A), its intersection is the content of itself, which comprises 4 works. This is not a single work (613) nor is it zero works (617), and so the set is stored for later use and a second iteration is begun.

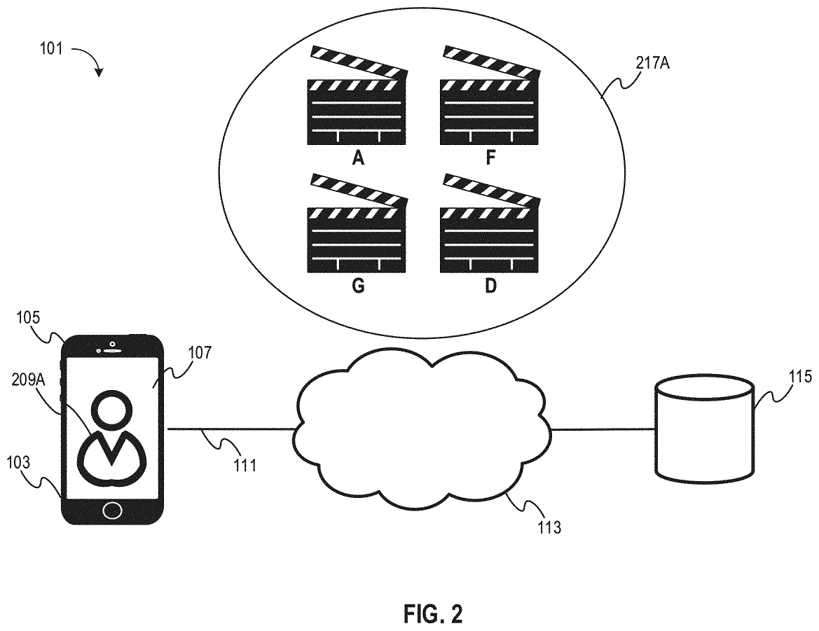

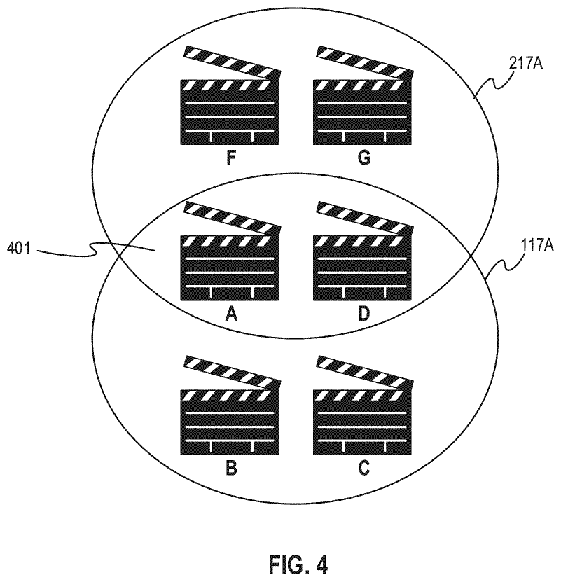

In FIG. 2, the second iteration takes a second sample (603) of the content (107) at another point in time, and identifies a second content element (209A). The method in FIG. 6 is used to detect and search the second content element (209A) and create a second result set (217 A) of works, A, F, G, and D, in which the second content element (209A) also appears. As shown in FIG. 4, the intersection (401) of result sets (117A) and (217A) comprises works A and D. The count of the intersection (401) is thus two, which is neither one (success) nor zero (error), and a third iteration is needed.

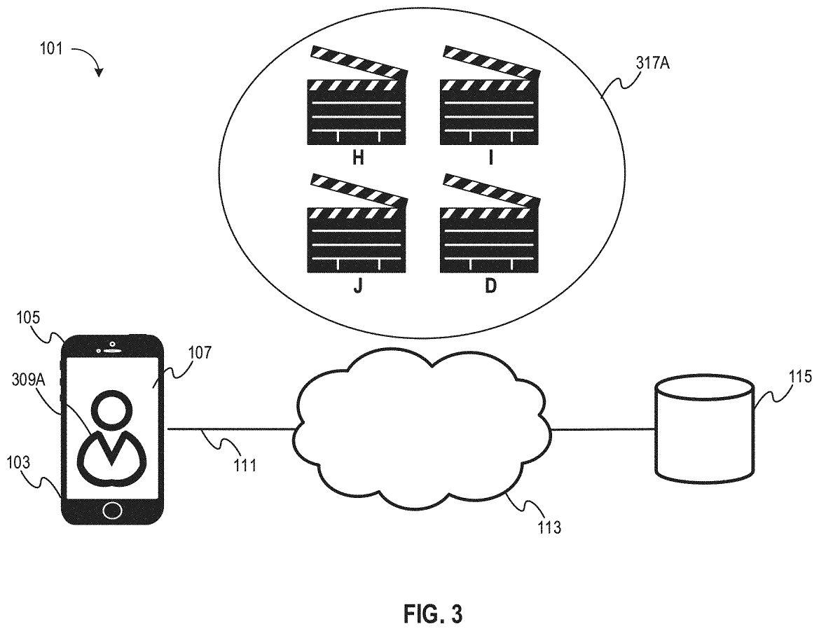

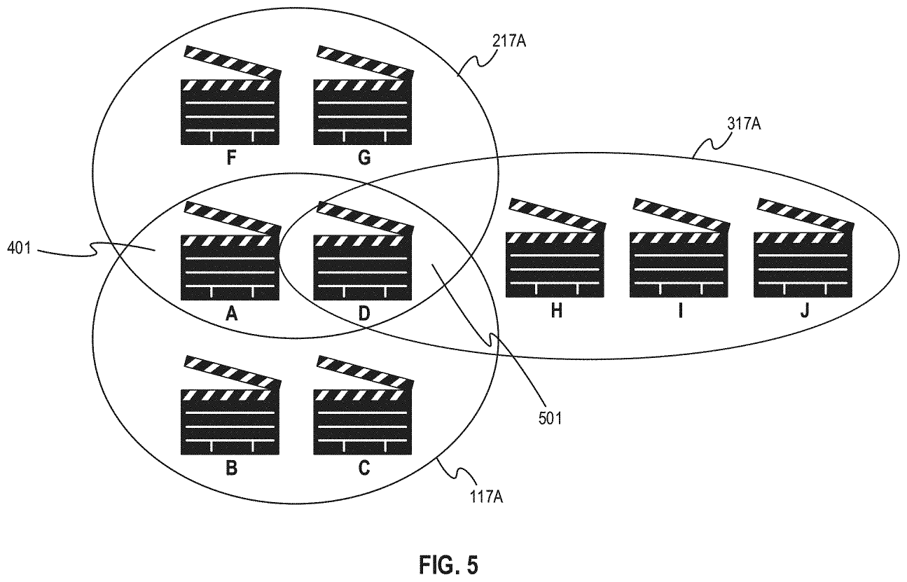

In FIG. 3, the third iteration takes a third sample (603) of the content (107) at yet another point in time, and identifies a third content element (309A). The method in FIG. 6 is used to detect and search the third content element (309A) and create a third result set (317 A) of works H, I, J, and D, in which the third content element (309A) also appears. As shown in FIG. 5, the intersection (501) of result sets (117A), (217A), and (317A) comprises work D. The count of the intersection (501) is thus one, the success condition, and the system returns the identification of work D as the identification of the content (107).

In certain cases, it may simply be impossible to identify the content (107) using these techniques for various reasons. This may happen when the intersection contains more than a single work (617) but no further content elements can be detected within the iteration or timing thresholds required for the implementation (621). Alternatively, the work may simply end and there is no further content to sample. In such circumstances, the method may return an error condition indicating that the work could not be identified (623). This condition is preferably different from the error condition resulting from a null intersection, because the cause of the error is different. In some example implementations, subsequent/additional sets of works generated from additional iterations are grouped together, and the identity of the source content is determined by finding the intersecting work between the group sets of works and prior sets of works.

It will be understood that the data representing the works identified in the sets may consist of more than merely the title of the work. Other information about the work may also be acquired and stored in the sets. This data may also be used to identify the work. For example, bibliographic data such as creation date, release date, length, format, and so forth, may be retrieved or determined from the database (115) and stored in association with the sets. This information may also be used to determine the original work if there are multiple duplicate identical or near-identical copies of an audiovisual work (for example, a re-release of the same film 50 years after the original release date of that film). Alternatively, this information may be subsequently retrieved later as needed, and as discussed elsewhere herein.

If an iteration has a null intersection, it means none of the content elements found were detected as being present in any shared content (107). As indicated above, this suggests that at least one content element was not correctly identified or that a search result is incomplete. In an embodiment, other steps may be taken to attempt to identify the content (107) after such a condition. For example, all of the samples and results may be discarded and the process restarted from scratch with new samples. It is possible that the error results from poor sample quality and re-sampling may resolve the error. In another embodiment, the samples that have already been taken may be re-examined for additional content. This may include looking for secondary or different categories of content and attempting to further identify the content (107) thereby.

In an embodiment, other techniques may also be used where the content (107) cannot be uniquely identified after a certain predetermined number of iterations or amount of time. For example, it is possible that the samples taken may be of a single lengthy scene in which only one actor appears. Until the scene ends, the process may not be able to detect any other content elements (109A) to create additional sets. In such circumstances, the software may halt the method shown in FIG. 6 before completion and switch to another method after a certain number of iterations without success, or after a certain amount of time passes, particularly if the ACR is being conducted in response to a real time user inquiry. In another embodiment, the software may continue the steps shown in FIG. 6 but change the scope or type of content detection performed. For example, if the system initially begins with actors, the software may switch to attempting to detect vehicles or buildings.

In an embodiment, additional data about the identified content elements may also be retrieved and used to narrow down the number of results in the intersections. For example, in an embodiment, it may be possible to estimate the age of a detected actor and, based on the actor's birthday, eliminate from the intersection those films in which the actor would have been too young or too old to appear as detected (e.g., by examining the bibliographic data for those films and comparing dates). Likewise, certain content elements (109A) can be used to refine and narrow the intersection based on dates. For example, if a vehicle or building is detected, it may be possible to also determine its year of manufacture or construction, and thereby eliminate from the intersection any films released before that date, when the vehicle or building could not have appeared because it did not yet exist.

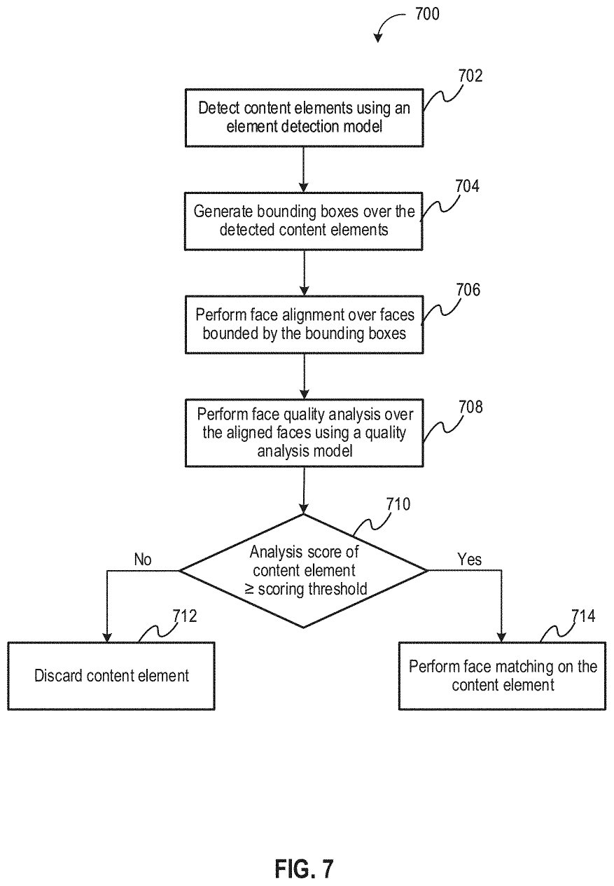

FIG. 7 illustrates an example process flow 700 of steps 605 and 607 of FIG. 6, using faces/actors as the scope or type of content detection. The content element detection process, step 605 of FIG. 6, begins at step 702, where content elements are detected using an element detection model. At step 704, the element detection model generates bounding boxes over the detected content elements, where each bounding box corresponds to a detected content element.

The content element identification process, step 607 of FIG. 6, begins at step 706, where face alignment is performed over the faces bounded by the bounding boxes. The face alignment process first searches for facial key points or facial landmarks over the bounding boxes to obtain geometric facial structures. The face alignment process then attempts to obtain alignment of the face through a combination of transformations that include, but are not limited to, translation, scale, rotation, etc.

At step 708, face quality analysis is performed using a quality analysis model. The quality analysis model takes various factors into account in generating analysis scores as model outputs. Such factors may include, but are not limited to, contrast, blur, noise, distortion, etc. Each analysis score is associated with a specific content element or face and is a valuation of the overall quality of the content element or face.

At step 710, a determination is made as to whether the analysis scores of the faces pass a scoring threshold. If an analysis score falls below the scoring threshold, then the associated content element or face is discarded at step 712. On the other hand, if an analysis score satisfies (meeting or exceeding) the scoring threshold, then face matching is performed on the content element at step 714.

At step 714, face matching is performed using extracted embeddings. The step begins by extracting embeddings of the faces. In various embodiments, a 512-dimensional vector embedding of the face is extracted for each content element. The dimensional vectors/embeddings are unique representations that a face recognition model produces when it examines the face. These dimensional vectors/embeddings contain mathematical distances (e.g. cosine) calculated between various faces. The closer two faces are in terms of similarities, the closer their points in the embedding space will be. The number of dimensions, 512, is exemplary only, and other number of dimensions may be utilized in vector generation.

The extracted embeddings are then run through a library of already indexed embeddings to find matches that are outputted as identities of the content elements/faces. In one embodiment, matching is performed using a nearest neighbors method to locate the top match and output the match as the identity of the content element or face. In various embodiments, the extracted embeddings may be received by a server, where the matching process is performed on the server.

In various embodiments, the successfully matched faces' 512-dimensional vectors and associated metadata are stored in an approximate nearest neighbor index in a database. The metadata may include information about the content element, associated analysis score, etc. When the database is queried, a content element's 512-dimensional vector is used to query the approximate nearest neighbor index, which returns the matched content element and associated metadata.

In various embodiments, detection, identification, finding, searching, extraction and/or matching is performed using a machine learning model. The machine learning model may include various types of models including models such as a neural network trained on media content or previously detected content elements. Other types of machine learning models may be used, such as decision tree models, associated rule models, neural networks including deep neural networks, inductive learning models, support vector machines, clustering models, regression models, Bayesian networks, genetic models, artificial-intelligence-based models, or various other supervised or unsupervised machine learning techniques, among others. The machine learning model can also intelligently deconstruct audiovisual works in real-time, identifying, for example, the people, brands and products that appear in an audio-visual work. The machine learning powered audio-visual analysis can also go well beyond just a program or advertisement appearing on a television screen, and it can understand product placement, logo appearances, and integrated advertising, which can provide advertisers with additional deeper insights into the value of advertising and product placement investments across every content platform viewed on the biggest television screen in the home.

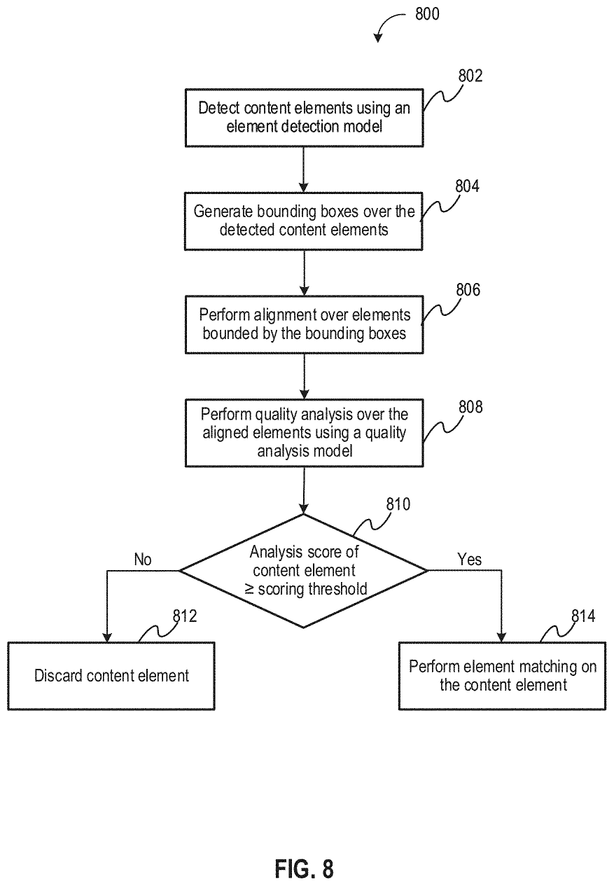

FIG. 8 illustrates an example process flow 800 of steps 605 and 607 of FIG. 6, where the scope/type of content detection other than a face is utilized. Examples of such scope/type may include, but not limited to, a person, vehicle, building, plant, animal, city, geographic feature, article of clothing, sign, textual or numeric information, slogan, logo, symbol, location, word, jingle, brand, trade name, trademark, landmark, visual work, audio work, audiovisual work, and/or any other product or item of unique interest. The content element detection process, step 605 of FIG. 6, begins at step 802, where content elements are detected using an element detection model. At step 804, the element detection model generates bounding boxes over the detected content elements, where each bounding box corresponds to a detected content element.

The content element identification process, step 607 of FIG. 6, begins at step 806, where alignment is performed over the elements bounded by the bounding boxes. The alignment process first searches for key points or landmarks over the bounding boxes to obtain element structures. The alignment process then attempts to obtain alignment of the element through a combination of transformations that include, but are not limited to, translation, scale, rotation, etc.

At step 808, a quality analysis is performed using a quality analysis model. The quality analysis model takes various factors into account in generating analysis scores as model outputs. Such factors may include, but are not limited to, contrast, blur, noise, distortion, etc. Each analysis score is associated with a specific content element and is a valuation of the overall quality of the content element.

At step 810, a determination is made as to whether the analysis scores of the content element pass a scoring threshold. If an analysis score falls below the scoring threshold, then the associated content element is discarded at step 812. On the other hand, if an analysis score satisfies (by, for example, meeting or exceeding) the scoring threshold, then element matching is performed on the content element at step 814.

At step 814, matching is performed using extracted embeddings. The step begins by extracting embeddings of the elements. In various embodiments, a 512-dimensional vector embedding of the element is extracted for each content element. The dimensional vectors/embeddings are unique representations that an element recognition model produces when it examines the element. These dimensional vectors/embeddings contain mathematical distances (e.g. cosine) calculated between various elements. The closer two elements are in terms of similarities, the closer their points in the embedding space will be. The number of dimensions, 512, is exemplary only, and other number of dimensions may be utilized in vector generation.

The extracted embeddings are then run through a library of already indexed embeddings to find matches that are outputted as the identities of the content elements. In one embodiment, matching is performed using a nearest neighbors method to locate the top match and output the match as the identity of the content element. In various embodiments, the extracted embeddings may be received by a server, whereby the matching process is performed on the server.

In various embodiments, the successfully matched content elements' 512-dimensional vectors and associated metadata are stored in an approximate nearest neighbor index in a database. The metadata may include information about the content element, associated analysis score, etc. When the database is queried, a content element's 512-dimensional vector is used to query the approximate nearest neighbor index, which returns the matched content element and associated metadata.

The foregoing example implementation may have various benefits and advantages, including, for example, a way of utilizing automated content recognition that avoids the need for watermarking or fingerprinting in the conventional content recognition process, and which avoids the need for a content-based reference library. As reference libraries impose significant overhead costs (e.g. maintenance and access to high-quality copies of content), non-fingerprint-based ACR significantly reduces expenditure over such upkeep while providing accurate outputs to the content recognition process. Additionally, the non-fingerprint-based ACR process significantly reduces network resource consumption when compared to the conventional fingerprinting method, as intersecting work discovery is being performed on content elements as opposed to large sized full samples. Also, non-fingerprint-based ACR can be performed by a machine learning model, such as the machine learning models discussed above.

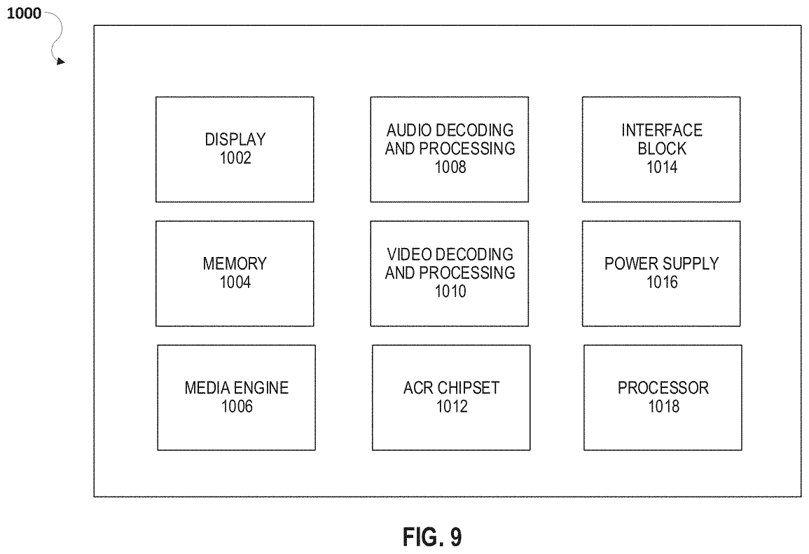

FIG. 9 illustrates an example user device 1000, which may include display elements (e.g., display screens or projectors) for displaying consumer content. In various embodiments, the user device 1000 may be a television, smartphone, computer, or the like as described in detail above. In various embodiments, the illustrated user device 1000 includes a display 1002. As will be appreciated, the display may enable the viewing of content on the user device 1000. The display may be of a variety of types, such as liquid crystal, light emitting diode, plasma, electroluminescent, organic light emitting diode, quantum dot light emitting diodes, electronic paper, active-matrix organic light-emitting diode, or the like. The user device 1000 further includes a memory 1004. As would be apparent to one of ordinary skill in the art, the device can include many types of memory, data storage, or computer-readable media, such as a first data storage for program instructions for execution by the at least one processor.

In various embodiments, the user device 1000 includes a media engine 1006. As used herein, the media engine 1006 may include an integrated chipset or stored code to enable the application of various media via the user device 1000. For example, the media engine 1006 may include a user interface that the user interacts with when operating the user device 1000. Further, the media interface 1006 may enable interaction with various programs or applications, which may be stored on the memory 1004. For example, the memory 1004 may include various third-party applications or programs that facilitate content delivery and display via the user device 1000.

In various embodiments, the user device 1000 further includes an audio decoding and processing module 1008. The audio decoding and processing module 1008 may further include speakers or other devices to project sound associated with the content displayed via the user device 1000. Audio processing may include various processing features to enhance or otherwise adjust the user's auditory experience with the user device 1000. For example, the audio processing may include feature such as surround-sound virtualization, bass enhancements, and the like. It should be appreciated that the audio decoding and processing module 1008 may include various amplifiers, switches, transistors, and the like in order to control audio output. Users may be able to interact with the audio decoding and processing module 1008 to manually make adjustments, such as increasing volume.

The illustrated embodiment further includes the video decoding and processing module 1010. In various embodiments, the video decoding and processing module 1010 includes components and algorithms to support multiple ATSC DTV formats, NTSC and PAL decoding, various inputs such as HDMI, composite, VGA, DVI, or S-Video inputs, or 2D adaptive filtering. Further, high definition and 3D adaptive filtering may also be supported via the video decoding and processing module 1010. The video decoding and processing module 1010 may include various performance characteristics, such as synchronization, blanking, and hosting of CPU interrupt and programmable logic 1/0 signals. Furthermore, the video decoding and processing module 1010 may support input from a variety of high definition inputs, such as High Definition Media Interface and also receive information from streaming services, which may be distributed via an Internet network.

As described above, the illustrated user device 1000 includes the ACR chipset 1012, which enables an integrated ACR service to operate within the user device 1000. In various embodiments, the ACR chipset 1012 enables identification of content displayed on the user device 1000 by video, audio, or watermark cues that are matched to a source database for reference and verification. In various embodiments, the ACR chipset 1012 may include fingerprinting to facilitate content matching. The illustrated interface block 1014 may include a variety of audio and/or video inputs, such as via a High Definition Media Interface, DVI, S-Video, VGA, or the like. Additionally, the interface block 1014 may include a wired or wireless Internet receiver. In various embodiments, the user device 1000 further includes a power supply 1016, which may include a receiver for power from an electrical outlet, a battery pack, various converters, and the like. The user device 1000 further includes a processor 1018 for executing instructions that can be stored on the memory 1004.

The specification and drawings are, accordingly, to be regarded in an illustrative rather than a restrictive sense. It will, however, be evident that various modifications and changes may be made thereunto without departing from the broader spirit and scope of the invention as set forth in the claims.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

What is claimed is:

1. A method for content recognition, the method comprising:
sampling a source content for performing content recognition;
detecting content elements from the sampled source content; and
identifying the detected content elements,
wherein detecting content elements from the sampled source content comprises:
detecting content elements using an element detection model; and
generating bounding boxes over each detected content element.

2. The method of claim 1, wherein identifying the detected content elements comprises:
for each detected content element;
performing alignment over each bounding box;
performing quality analysis over the aligned bounding boxes to generate analysis scores, each analysis score being associated with a detected content element; and
performing matching on each detected content element associated with any analysis score meeting or exceeding a scoring threshold.

3. The method of claim 2, wherein performing matching on each detected content element comprises:
extracting embedding associated with the content element;
matching the extracted embedding against stored embeddings to locate an identity of the element; and
outputting the located identity as an identity of the content element.

4. The method of claim 3, wherein matching the extracted embedding against the stored embeddings to locate an identity of the content element is performed on a server.

5. The method of claim 1, further comprising:
for each of the identified content elements:
searching for at least one matching work associated with the identified content element;
grouping the at least one matching work with the identified content element into a set of works associated with the identified content element; and
determining whether an intersecting work exists between the sets of works.

6. The method of claim 5, further comprising:
finding one intersecting work between the sets of works, and outputting the intersecting work as an identity of the source content.

7. The method of claim 5, further comprising:
finding no intersecting work between the sets of works, discarding the sets of works, and restarting content sampling process.

8. The method of claim 5, further comprising:
finding more than one intersecting work among the sets of works:
detecting an additional content element from the sampled source content;
identifying the detected additional content element;
searching for at least one additional matching work associated with the identified additional content element;
grouping the at least one additional matching work associated with the identified additional content element into an additional set of works; and
determining whether an intersecting work exists between the sets of works and the additional set of works.

9. The method of claim 8, further comprising:
finding one intersecting work among the sets of works and the additional set of works, and outputting the intersecting work as an identity of the source content.

10. The method of claim 8, further comprising:
finding no intersecting work among the sets of works and the additional set of works, discarding the sets of works, and restarting content sampling process.

11. The method of claim 1, wherein the source content comprises an audio, visual, or audiovisual work.

12. The method of claim 1, wherein the content element is a person, vehicle, building, plant, animal, city, geographic feature, article of clothing, sign, textual or numeric information, slogan, logo, symbol, location, word, jingle, brand, trade name, trademark, landmark, visual work, audio work, or audiovisual work.

13. A method for content recognition, the method comprising:
extracting, by a server, an embedding associated with a content element;
matching, by the server, the embedding against stored embeddings at a library to locate an identity of the content element; and
outputting, by the server, the located identity,
wherein at least one of extracting or matching is performed by a machine learning model.

14. The method of claim 13, further comprising:
sampling, by a user device, a source content;
detecting, by the user device, content elements from the sampled source content using an element detection model, and generating bounding boxes over the detected content elements; and
identifying the detected content elements by:
performing alignment over the bounding boxes;
performing quality analysis over the aligned bounding boxes to generate analysis scores, each analysis score being associated with a detected content element; and
performing embedding extraction on each detected content element associated with an analysis score meeting or exceeding a scoring threshold.

15. The method of claim 14, further comprising:
for each of the identified content elements:
searching, by the server, for a corresponding set of matching works associated with each of the identified content elements;
grouping the set of matching works associated with each of the identified content elements into a set of works associated with the identified content element, and
determining whether an intersecting work exists between the sets of works.

16. The method of claim 15, further comprising:
finding one intersecting work among the sets of works; and
outputting the intersecting work as an identity of the source content.

17. The method of claim 15, further comprising:
finding more than one intersecting work among the sets of works:
detecting an additional content element from the sampled source content;
identifying the detected additional content element;
searching for at least one additional matching work associated with the identified additional content element;
grouping the at least one additional matching work associated with the identified additional content element into an additional set of works; and
determining whether an intersecting work exists between the sets of works and the additional set of works.

18. The method of claim 17, further comprising:
finding one intersecting work among the sets of works and the additional set of works, and outputting the intersecting work as an identity of the source content.

19. The method of claim 17, further comprising:
finding no intersecting work among the sets of works, discarding the sets of works, and restarting content sampling process.

20. The method of claim 14, wherein the source content comprises an audio, visual, or audiovisual work.

21. The method of claim 13, wherein the content element is a person, vehicle, building, plant, animal, city, geographic feature, article of clothing, sign, textual or numeric information, slogan, logo, symbol, location, word, jingle, brand, trade name, trademark, landmark, visual work, audio work, or audiovisual work.

22. A method for content recognition, the method comprising:
sampling, by a processor, a source content;
detecting, by the processor, a first content element from the sampled source content;
identifying, by the processor, the detected first content element;
searching, by the processor, for at least one first matching work associated with the identified first content element;
grouping, by the processor, the at least one first matching work associated with the identified first content element into a first set of works;
detecting, by the processor, a second content element from the sampled source content;
identifying, by the processor, the detected second content element;
searching, by the processor, for at least one second matching work associated with the identified second content element;
grouping, by the processor, the at least one second matching work associated with the identified second content element into a second set of works; and
determining, by the processor, whether an intersecting work exists between the first set of works and the second set of works.

23. The method of claim 22, further comprising:
finding one intersecting work among the first set of works and the second set of works, and outputting, by the processor, the intersecting work as an identity of the source content.

24. The method of claim 23, further comprising
wherein the identifying, by the processor, the detected first content element comprises identifying at least one specific categorical classification for the detected first content element; and
wherein the identifying, by the processor, the detected second content element comprises identifying at least one specific categorical classification for the detected second content element.

25. The method of claim 22, wherein the source content comprises an audio, visual, or audiovisual work.

26. The method of claim 22, further comprising:
finding no intersecting work among the first set of works and the second set of works, and returning an error message requesting manual review or troubleshooting.

27. The method of claim 22, further comprising:
finding more than one intersecting work among the first set of works and the second set of works:
detecting, by the processor, a third content element from the sampled source content;
identifying, by the processor, the detected third content element;
searching, by the processor, for at least one third matching work associated with the identified third content element;
grouping, by the processor, the at least one third matching work associated with the identified third content element into a third set of works; and
determining, by the processor, whether an intersecting work exists between the first set of works, the second set of works, and the third set of works.

28. The method of claim 27, further comprising:
finding one intersecting work among the first set of works, the second set of works, the third set of works, and outputting, by the processor, the intersecting work as an identity of the source content.

29. The method of claim 27, further comprising:
finding no intersecting work among the first set of works, the second set of works, and the third set of works, and returning an error message requesting manual review or troubleshooting.

30. The method of claim 27, further comprising:
finding more than one intersecting work among the first set of works, the second set of works, and the third set of works:
iteratively performing an additional content recognition process until at least one of an iteration threshold or a time threshold is exceeded, or the source content is identified before the iteration threshold or the time threshold is exceeded, the additional content recognition process comprising:
detecting, by the processor, an additional content element from the sampled source content;
identifying, by the processor, the detected additional content element;
searching, by the processor, for at least one additional matching work associated with the identified additional content element;
grouping, by the processor, the at least one additional matching work associated with the identified additional content element into an additional set of works;
adding the additional set of works to a group sets of works;
determining, by the processor, whether an intersecting work exists between the first set of works, the second set of works, the third set of works, and the group sets of works; and
finding an intersecting work among the first set of works, the second set of works, the third set of works, and the group sets of works, and outputting, by the processor, the intersecting work as an identity of the source content.

31. The method of claim 22, further comprising:
finding no intersecting work among the first set of works and the second set of works, discarding the first set of works and the second set of works, and restarting content sampling process.

32. The method of claim 22, wherein the content element is a person, vehicle, building, plant, animal, city, geographic feature, article of clothing, sign, textual or numeric information, slogan, logo, symbol, location, word, jingle, brand, trade name, trademark, landmark, visual work, audio work, or audiovisual work.
